(19) United States
(12) Patent Application Publication
(10) Pub. No.: US 2011/0088662 A1
(43) Pub. Date: Apr. 21, 2011

(54) METHOD OF PACKAGING A MEMBRANE FOR USE IN A VENTING VALVE

(75) Inventor: Matthew Lorenz Erdmann, Ypsilanti, MI (US)

(73) Assignee: Eaton Corporation, Cleveland, OH (US)

(21) Appl. No.: 12/582,197

(22) Filed: Oct. 20, 2009

(51) Int. Cl. F02M 33/02; F16K 24/04

(52) U.S. Cl. 123/518

(57) ABSTRACT

A venting valve comprises a cover including a flow path in fluid communication with an evaporative emissions system and a liquid discriminating and vapor permeable membrane connected to the cover. At least a portion of the outer surface of the membrane comprises a plurality of alternating curved crests and valleys. In other embodiments, the membrane comprises a first and second layer defining a gap therebetween, wherein at least a portion of the membrane is spirally wound. In other embodiments, the venting valve includes at least one protrusion configured to support and shape the membrane, wherein at least a portion of the membrane is curved.

### TECHNICAL FIELD

The present invention relates to valves including liquid discriminating and vapor permeable membranes.

### BACKGROUND

Fuel level responsive venting valves are conventionally used in automobile fuel tanks. Venting valves may be located in the fuel tank to remain open when the fuel is below a certain level and to close when the fuel reaches the valve. Two common applications of these valves are “rollover” valves, which respond to abnormal fuel levels or unusual vehicle angles by closing a vapor outlet from the tank, and fuel shutoff or “fill control” valves which are positioned to close when the fuel tank reaches the “full” level during refueling.

To protect the emissions system against fuel spills from the vapor vent line in a fuel tank in the event of a vehicle rollover, venting valves are configured to close the vapor vent when the vehicle is tilted beyond a safe threshold amount from the normal upright position. These venting valves may employ a float that closes the valve when the liquid level of the fuel rises above a predetermined level to prevent liquid fuel from sloshing out of the vapor vent either during normal operation or in the event of rollover.

Venting valves vent fuel vapor from a vehicle fuel tank to the atmosphere or to an evaporative emissions system, which may include a carbon canister. Such valves typically vent the interior of the fuel tank to the evaporative emissions system when the fuel in the tank is below the level of the valve and close when the fuel level surges (e.g., in a rollover situation or during fuel sloshing from driving maneuvers). In some cases, rollover valves may also be submerged at the end of a fuel fill. Closing the valve in response to surging liquid fuel levels prevents the overflow of liquid fuel into the evaporative emissions system. If the valve is used as a fill-control vent valve, the valve may generally close in response to a full fuel level, creating a pressure head within the fuel tank and filler pipe to operate an automatic shutoff apparatus built into the fuel fill nozzle.

Although mechanical floats (which may include floats, springs, other mechanical means, or combinations thereof) may be used to partially and/or completely close fuel vent valves, they involve moving parts and can be relatively complex. Alternative methods to prevent liquid fuel from entering the vapor recovery system and/or to partially or completely seal the fuel vent in case of vehicle rollover may involve using a membrane in place of a mechanical means, such as a float. The membrane may be capable of venting vapor (e.g., fuel vapor) from a container (e.g., fuel tank) to a vapor recovery system. The membrane may further be configured to prevent liquid from passing through and accordingly can also serve the rollover valve function. In a conventional membrane design, the membrane may be substantially disk shaped and may extend over a substantial portion of a cover for the vent valve.

In order to meet the functional requirements of the venting valve (e.g., based on the flow needs of the venting valve), the membrane may require a significant amount of surface area. In order to increase the surface area of a substantially disk-shaped membrane, there is an undesirable and significant increase in size and packaging (i.e., the disk-shaped membrane must be increased in diameter and circumference in order to increase the surface area). Accordingly, it may be desirable to utilize a method of packaging a membrane that has an increased membrane surface area to meet functional requirements but maintains substantially the same dimensions and physical space requirements as conventional valves.

### SUMMARY

In an embodiment, a venting valve comprises a cover including a flow path in fluid communication with an evaporative emissions system; and a liquid discriminating and vapor permeable membrane connected to the cover. At least a portion of the outer surface of the membrane may comprise a plurality of alternating curved crests and valleys.

In another embodiment, a venting valve comprises a cover including a flow path in fluid communication with an evaporative emissions system; and a liquid discriminating and vapor permeable membrane connected to the cover. The membrane may comprise a first and second layer defining a gap therebetween. At least a portion of the membrane may be spirally wound.

In another embodiment, a venting valve comprises a cover including a flow path in fluid communication with an evaporative emissions system and a liquid discriminating and vapor permeable membrane connected to the cover. At least a portion of the membrane may be curved, and at least one protrusion may be configured to support and shape the membrane.

### BRIEF DESCRIPTION OF THE DRAWINGS

Embodiments of the invention will now be described, by way of example, with reference to the accompanying drawings, wherein:

FIG. 1 is a schematic view of a vehicle fuel system employing a venting valve in accordance with an embodiment of the invention.

FIG. 2A is a partial perspective view of a venting valve of FIG. 1 including a membrane in accordance with an embodiment of the invention.

FIG. 2B is a cross-sectional view of a venting valve of FIG. 1 including a membrane in accordance with en embodiment of the invention.

FIGS. 2C and 2D are sectional views cut along plane 2C-2C on FIG. 2B.

FIG. 2E is a cross-sectional view of a venting valve of FIG. 1 including a housing in accordance with an embodiment of the invention.

FIG. 2F is perspective view of the housing of FIG. 2E in accordance with an embodiment of the invention.

FIGS. 3A-3B are top views of a membrane for a venting valve of FIG. 1 in accordance with another embodiment of the invention.

FIG. 3C is a side view of the membrane shown in FIGS. 3A-3B.

FIG. 4 is a side view of a membrane for a venting valve of FIG. 1 in accordance with another embodiment of the invention.

FIGS. 5A-5B are perspective views of a membrane for a venting valve of FIG. 1 in accordance with another embodiment of the invention.

FIG. 6 is a perspective view of a membrane for a venting valve of FIG. 1 in accordance with another embodiment of the invention.

FIG. 7 is a perspective view of a venting valve of FIG. 1 including a membrane in accordance with another embodiment of the invention.

FIG. 8 is another perspective view of the venting valve of FIG. 7.

FIG. 9 is a partial perspective view of the membrane of the venting valve of FIGS. 7-8 in accordance with an embodiment of the invention.

FIG. 10 is a partial perspective view of a membrane for a venting valve of FIG. 1 in accordance with another embodiment of the invention, including additional supporting structure for the membrane.

FIGS. 11A-11C are perspective views of a membrane for a venting valve of FIG. 1 in accordance with other embodiments of the invention.

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as embodied by the appended claims.

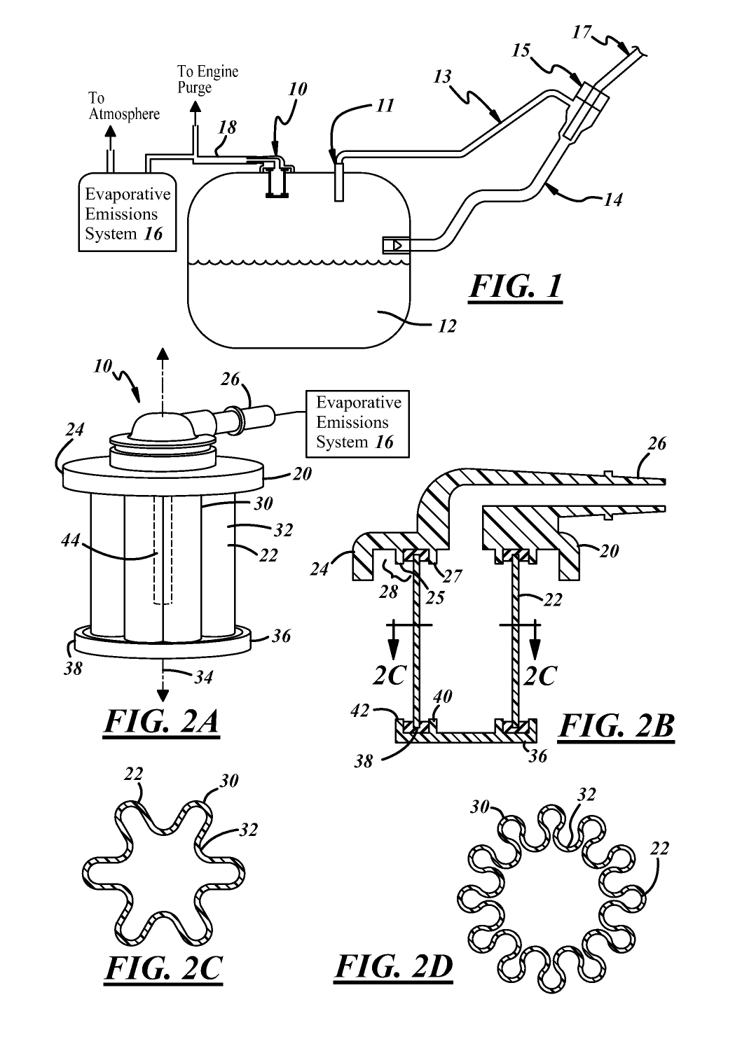

FIG. 1 illustrates a schematic view of a vehicle fuel system. The vehicle fuel system may include a dip tube 11, a fuel tank 12, a recirculation line 13, a fill cup 15, and a refueling nozzle 17. The fuel tank 12 may contain liquid fuel. The vehicle fuel system may also include a filler pipe 14 for introducing fuel into the fuel tank 12. The vehicle fuel system may further include an evaporative emissions system 16 (e.g., carbon canister) to which fuel vapor is vented from the tank 12 through valve 10 via a vent line 18. Venting valve 10 may be configured so that vapor may rise through the venting valve 10. The venting valve 10 may be generally mounted in a vent hole in a fuel tank 12 of a vehicle fuel system. Although various elements of a vehicle fuel system are generally described and illustrated, the venting valve 10 in accordance with the present invention may be utilized in any number of vehicle fuel systems which omit certain elements that are described or illustrated and/or include additional elements that are not described or illustrated herein. The venting valve 10 may be configured for use between a vehicle fuel tank vent and the vapor recovery system 16.

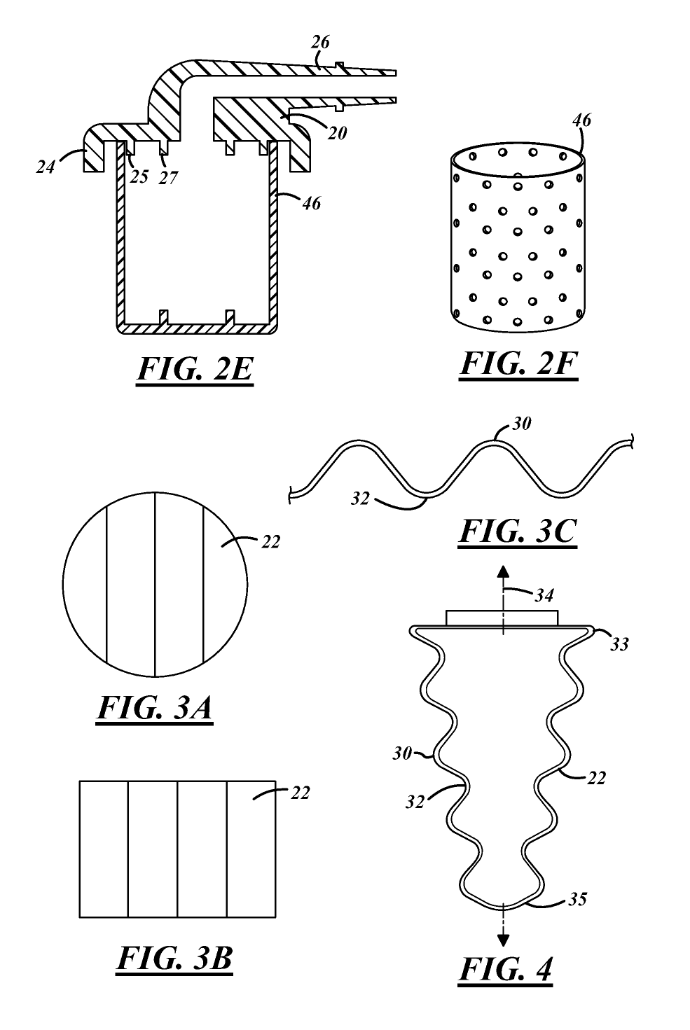

Referring now to FIG. 2A, the venting valve 10 may comprise a cover 20 (e.g., cap) and a liquid discriminating and vapor permeable membrane 22. The cover 20 may be molded, for example, from a fuel resistant plastic and may be mounted in a wall of the fuel tank 12. The cover 20 may be mounted to the fuel tank 12 using any known and/or conventional method and/or manner, including for example, welding (e.g., ultrasonic welding), bonding (e.g., with adhesive), a camlock design with an elastomeric seal, and/or fasteners (e.g., screws, bolts, rivets, brads, etc.). The cover 20 may include a flange 24 configured to support the venting valve 10 in a fuel tank 12 of a vehicle fuel system. For example, the flange 24 may be generally circular in shape in accordance with an embodiment of the invention. The cover 20 may further include a flow path 26 (e.g., a port, a line, or any other path). Flow path 26 may be configured for fluidly connecting a venting orifice (to which vapor may rise through the venting valve 10) to the evaporative emissions system 16 (e.g., carbon canister). Accordingly, flow path 26 of cover 20 may be in fluid communication with the evaporative emissions system 16 and may allow for the transfer of vapor from fuel tank 12 to the evaporative emissions system 16.

In accordance with an embodiment of the invention, the membrane 22 of venting valve 10 may be connected to cover 20. For example and without limitation, the venting valve 10 may include a means 28 for connecting the membrane 22 to the cover 20. Means 28 may also be configured to ensure that the flow path of fluid from the fuel tank 12 is through membrane 22 (i.e., membrane 22 cannot be bypassed). Referring now to FIG. 2B, in accordance with an embodiment of the invention, the membrane 22 of venting valve 10 may be directly connected to cover 20. For example, in an embodiment, the means 28 for connecting the membrane 22 to the cover 20 may include one or more projections 25, 27 defining a channel into which the membrane 22 may be disposed. The membrane 22 may be connected to the cover 20 using adhesive located in the channel defined by the projections 25, 27, insert molding, or otherwise embedding the membrane. The membrane 22 may further utilize an end cap 36 as described further herein in accordance with an embodiment of the invention. In accordance with another embodiment, means 28 may comprise a post 29 that is substantially centered relative to cover 20 of venting valve 10 in an embodiment of the invention, as generally illustrated in FIG. 7, for example. The post 29 may comprise plastic in an embodiment of the invention. The post 29 may be connected to the cover 20 using any known and/or conventional method and/or manner, including, for example and without limitation, an insert molding process, welding (e.g., ultrasonic welding), heat sealing, bonding (e.g., with adhesives), a combination thereof, or any number of other processes. The post 29 may also be connected to the membrane 22. The post 29 may be connected to the membrane 22 using any known and/or conventional method and/or manner, including for example and without limitation, an insert molding process, welding (e.g., ultrasonic welding), heat sealing, bonding (e.g., with adhesives), a combination thereof, or any number of other processes. Although means 28 are described in detail as projections 25, 27 and/or post 29 in accordance with various embodiments of the invention, means 28 may comprise any element and/or member and/or process that is configured to connect the membrane 22 to cover 20 and to ensure that the flow path for fluid from the fuel tank 12 is through the membrane 22 (i.e., that fluid cannot bypass membrane 22).

The membrane 22 may be configured to allow passage of air and/or fuel vapor while blocking passage of liquid fuel. The membrane 22 may be a liquid discriminating membrane. In accordance with an embodiment of the invention, the membrane 22 may be configured so that it does not change the hydrocarbon concentration of the air and/or fuel vapor that passes through the membrane 22. Fuel vapor may enter the venting valve 10 at the fuel tank side of the venting valve. To increase the surface area of the membrane 22 while maintaining substantially the same dimensions and physical space requirements as conventional membrane packaging for venting valves (e.g., substantially disk shaped membranes), the membrane 22 may comprise a number of various packages or methods for packaging as described herein.

Referring to FIGS. 2A, 2C, and 2D, in accordance with embodiments of the invention, the membrane 22 may comprise a rippled, corrugated, and/or wavy membrane package. In particular, at least a portion of the outer surface of the membrane 22 may comprise a plurality of alternating curved crests 30 and valleys 32 that define ripples, corrugations, and/or waves on the outer surface of the membrane 22. In other words, at least a portion of the outer surface of the membrane 22 has a substantially sinusoidal profile. The membrane 22 may be formed into a substantially columnar shape, having a longitudinal axis 34, in accordance with an embodiment of the invention and as generally illustrated in FIG. 2A. The longitudinal axis 34 of the substantially columnar membrane 22 may extend perpendicularly from cover 20. The ripples, corrugations, and/or waves defined by the curved crests 30 and valleys 32 may also extend along the longitudinal axis 34 of the substantially columnar membrane 22. The membrane 22 may form a hollow member in accordance with an embodiment of the invention. Although the membrane 22 is described as being a substantially columnar hollow member, the membrane 22 may comprise any number of other shapes in other embodiments.

For example, referring now to FIGS. 3A-3B which show top views of a membrane 22 for use with a venting valve 10 in accordance with another embodiment of the invention, the membrane 22 may be not curved into a substantially cylindrical hollow member. Instead, the membrane 22 may be relatively flat. As generally illustrated in FIG. 3A, the membrane 22 may be substantially circular in shape and/or disk-shaped. As generally illustrated in FIG. 3B, the membrane 22 may be substantially rectangular in shape. Although these two shapes are described and illustrated, the membrane 22 may comprise any number of shapes, including, for example, irregular shapes, in other embodiments of the invention. As best seen in the side view illustrated in FIG. 3C, the membrane 22 continues to comprise a plurality of alternating curved crests 30 and valleys 32 that define ripples, corrugations, and/or waves on the outer surface of the membrane 22. Accordingly, the membrane 22 is not actually flat, but has a substantially sinusoidal profile and continues to have an increased surface area because of the ripples, corrugations, and/or waves formed on the outer surface. The membrane 22 may be connected to venting valve 10 using means 28 (e.g., projections and/or a post configured to connect membrane 28 to cover 20 and/or any known and/or conventional method and/or manner, including for example, an insert molding process, welding (e.g., ultrasonic welding), heat sealing, bonding (e.g., with adhesives), a combination thereof, or any number of other processes). In accordance with an embodiment of the invention, the means 28 may comprise a direct connection between membrane 22 and cover 20 in accordance with an embodiment of the invention such that no separate connecting element (such as projections or a post) is necessary.

For another example of a rippled, corrugated, and/or wavy membrane package that does not include a substantially columnar hollow member, reference is now made to FIG. 4. The membrane 22 may be formed into a substantially wedge-shaped and/or V-shaped package. A first end 33 of the membrane 22 may be wider than a second opposing end 35 of the membrane 22. However, at least a portion of the outer surface of the membrane 22 may continue to comprise a plurality of alternating curved crests 30 and valleys 32 that define ripples, corrugations, and/or waves on the outer surface of the membrane 22. Accordingly, at least a portion of the outer surface of the membrane 22 may have a substantially sinusoidal profile. The ripples, corrugations, and/or waves may extend perpendicularly to the longitudinal axis 34 of the substantially wedge-shaped and/or V-shaped membrane 22. The membrane 22 may be connected to venting valve 10 using means 28 described herein and/or any known and/or conventional method and/or manner, including for example, an insert molding process, welding (e.g., ultrasonic welding), heat sealing, bonding (e.g., with adhesives), a combination thereof, or any number of other processes.). In accordance with an embodiment of the invention, the means 28 may comprise a direct connection between membrane 22 and cover 20 in accordance with an embodiment of the invention such that no separate connecting element (such as projections or a post) is necessary. One or more substantially triangular shaped pieces (not shown) may be used to seal the edges of the membrane 22 in order to maintain a closed inner vapor space separate from the fuel tank vapor space.

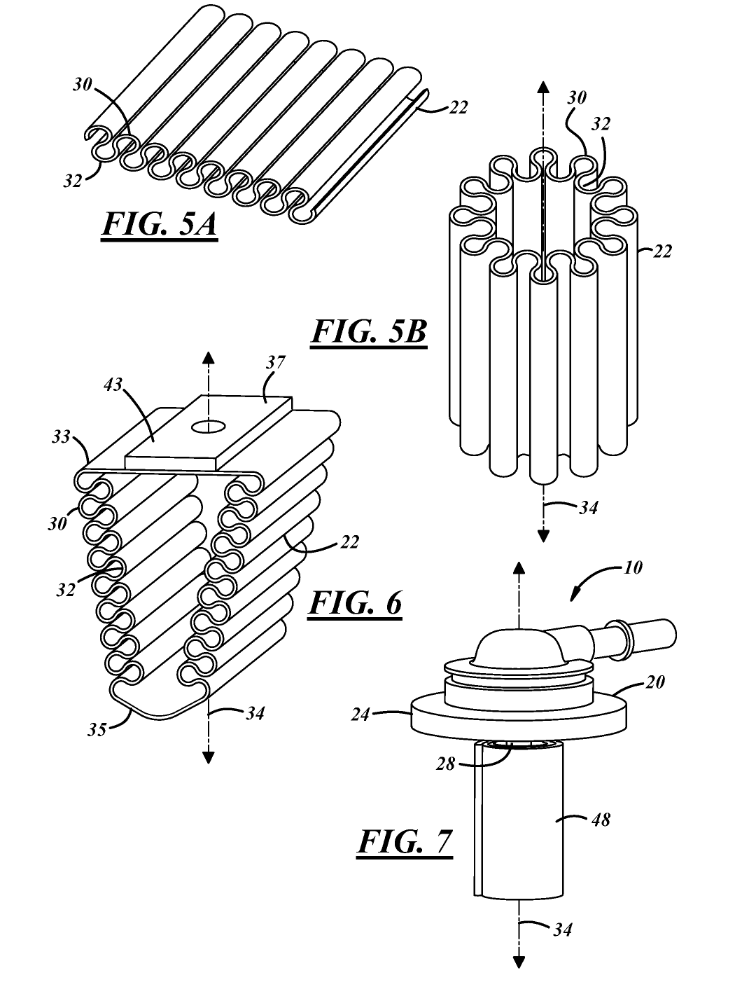

In accordance with another embodiment of the invention, the membrane 22 may comprise a ribbon-like membrane package. Referring now to FIGS. 2D and 5A-5B, at least a portion of the outer surface of the membrane 22 may continue to comprise a plurality of alternating curved crests 30 and valleys 32. However, as opposed to creating relatively shallow ripples, corrugations, and/or waves on the outer surface of the membrane, at least one of the plurality of curved crests 30 may have a profile that is at least substantially hemispherical. Also, in some embodiments, at least one of the plurality of curved valleys 32 may have a profile that is at least substantially hemispherical. In some embodiments, each of the plurality of curved crests 30 and/or valleys 32 may have a profile that is at least substantially hemispherical. In accordance with an embodiment of the invention, at least one of the plurality of curved crests 30 and/or at least one of the plurality of curved valleys 32 may have a profile that extends about equal to or greater than about 180° of a circle. In some embodiments, each of the plurality of curved crests 30 and/or valleys 32 may have a profile that extends about equal to or greater than about 180° of a circle. In accordance with an embodiment of the invention, at least one of the plurality of curved crests 30 may have a profile that extends at least about 270° of a circle. In some embodiments, at least one of the plurality of curved valleys may have a profile that extends at least about 270° of a circle. In some embodiments, each of the plurality of curved crests 30 and/or valleys 32 may have a profile that extends about equal to or greater than about 270° of a circle. Accordingly, the ripples, corrugations, and/or waves on the outer surface may be more pronounced than those generally illustrated in FIGS. 3A-3C. In other words, at least a portion of the outer surface of the membrane 22 may have a substantially corrugated profile.

The membrane 22 may also be formed in to a substantially columnar shape, having a longitudinal axis 34, in accordance with an embodiment of the invention and as generally illustrated in FIG. 5B. The longitudinal axis 34 of the substantially columnar membrane may extend perpendicularly from cover 20. The membrane 22 may be connected to venting valve 10 using means 28 (e.g., projections and/or a post and/or any known and/or conventional method and/or manner, including for example, an insert molding process, welding (e.g., ultrasonic welding), heat sealing, bonding (e.g., with adhesives), a combination thereof, and/or a direct connection between membrane 22 and cover 20, or any number of other processes and/or embodiments). The pronounced ripples and/or waves may extend along the longitudinal axis 34 of the substantially columnar membrane 22. The membrane 22 may form a hollow member in accordance with an embodiment of the invention. Although the membrane 22 is described as being a substantially cylindrical columnar member, the membrane 22 may comprise any number of other shapes in other embodiments.

For example, as generally illustrated in FIG. 6, the membrane 22 may be formed into a substantially wedge-shaped and/or V-shaped package. A first end 33 of the membrane 22 may be wider than a second opposing end 35 of the membrane 22. However, at least a portion of the outer surface of the membrane 22 continues to comprise a plurality of alternating curved crests 30 and valleys 32 that define a rippled profile as generally shown in FIG. 5A on the outer surface of the membrane 22. Accordingly, in other words, at least a portion of the outer surface of the membrane 22 has a substantially corrugated profile. The ripples may extend perpendicularly to the longitudinal axis 34 of the substantially wedge-shaped and/or V-shaped membrane 22. The membrane 22 may be connected to venting valve 10 using means 28 (e.g., projections and/or a post and/or any known and/or conventional method and/or manner, including for example, an insert molding process, welding (e.g., ultrasonic welding), heat sealing, bonding (e.g., with adhesives), a combination thereof, and/or a direct connection between membrane 22 and cover 20, or any number of other processes and/or embodiments). As generally illustrated in FIG. 6, means 28 may comprise plate 37 that is generally shown at the first wider end 33 of the membrane 22. Plate 37 may be configured for connection to membrane 22 using an insert molding process, welding (e.g., ultrasonic welding), heat sealing, bonding (e.g., with adhesives), or a combination thereof. Plate 37 may be considered an end cap in accordance with some embodiments of the invention. One or more substantially triangular shaped pieces (not shown) may be used to seal the edges of the membrane 22 in order to maintain a closed inner vapor space separated from the fuel tank vapor space.

Referring back to FIG. 2B, in accordance with various embodiments of the invention, the venting valve 10 may further comprise a first end cap 36. First end cap 36 may be connected to a first end 38 of the hollow member formed by membrane 22. First end cap 36 may be configured for sealing the first end 38 of the hollow member and/or retaining the shape of the hollow member. First end cap 36 may be connected to membrane 22 using any known and/or conventional method and/or manner in the art, including for example, adhesives. First end cap 36 may include a plurality of projections 40, 42 defining a channel into which the membrane 22 may be disposed. FIG. 2B generally shows first end cap 36 connected to membrane 22 using adhesive. Venting valve 10 may further comprise a second end cap (not shown) in accordance with some embodiments of the invention. The second end cap may be connected to a second end of the hollow member formed by membrane 22 that opposes the first end 38. The second end cap may be used in addition to and/or as part of means 28 for connecting the membrane 22 to the cover 20. The second end cap, if any, may also be connected to membrane 22 using any known and/or conventional method an/or manner in the art, including for example, adhesives. The second end cap may include a hole for vapor flow. The hole may in fluid communication with the flow path 26 of cover 20. Vapor may flow from fuel tank 12, through membrane 22, through the hole of the second end cap and/or through cover 20, through the flow path 26, and to evaporative emissions system 16. In this way, the membrane 22 provides two distinct vapor spaces (i.e., the first vapor space is inside the fuel tank 12 and the second vapor space is outside the fuel tank 12). Although first end caps 36 and second end caps are described in detail, end caps may not necessarily be used in connection with the embodiments of the invention. For example and without limitation, first end cap 36 may not be used in connection with wedge-shaped and/or V-shaped membranes generally illustrated in FIGS. 4 and 6. For another example, holes for vapor flow may be placed directly in the membrane itself.

Referring now to FIG. 2A, in accordance with an embodiment of the invention, the venting valve 10 may further comprise a structural support member 44 extending through the hollow member defined by the membrane 22. The structural support member 44 may be configured to be disposed in the hollow member. In one embodiment, the support member 44 may comprise a solid support. In other embodiments, the support member 44 may comprise a mesh structure support. The support member 44 may be generally cylindrical or columnar in an embodiment. Although the support member 44 is described as being generally cylindrical or columnar, the support member 44 may, however, comprise any number of other shapes in other embodiments. The support member 44 may extend along the longitudinal axis 34 of membrane 22. The support member 44 may be configured for press-fit insertion through the hollow member defined by the membrane 22. The support member 44 may function as a gap spacer in some embodiments of the invention, and may be configured to maintain the gap between opposing sides of the membrane 22. For example, a support member may be configured to support the wedge-shaped and/or V-shaped membrane 22 generally shown in FIGS. 4 and 6, and to maintain a gap between opposing sides of the membrane 22. The support member 44 may also comprise means 28 for connecting the membrane 22 to the cover 20 in accordance with an embodiment of the invention.

In some embodiments, the venting valve 10 may further comprise a housing 46 that at least partially surrounds (e.g., is exterior to) the membrane 22 as generally illustrated in FIGS. 2E-2F. The housing 46 may be cylindrical or generally cylindrical in shape in accordance with an embodiment of the invention. The housing 46 may be configured to prevent liquid fuel from splashing onto the membrane 22, which could potentially affect the functionality of the membrane 22. The housing 46 may also be configured to prevent external damage (e.g., crushing) of the membrane 22. Although the housing 46 is generally illustrated as surrounding the membrane 22, the housing 46 does not have to surround and/or be exterior to the membrane 22. In accordance with various embodiments of the invention, the housing 46 may be interior to the membrane 22. Such an embodiment with an interior housing 46 may still be configured to prevent external damage (e.g., crushing) of the membrane 22, but would not necessarily be configured for splash protection. In accordance with some embodiments of the invention, the housing 46 may be perforated (as generally illustrated in FIG. 2F), may include slits, may comprise mesh, and/or any other similar variation configured to permit venting of the housing 46. Although a housing 46 is described in connection with venting valve 10, the housing 46 is not necessary and may not be utilized in accordance with some embodiments of the invention.

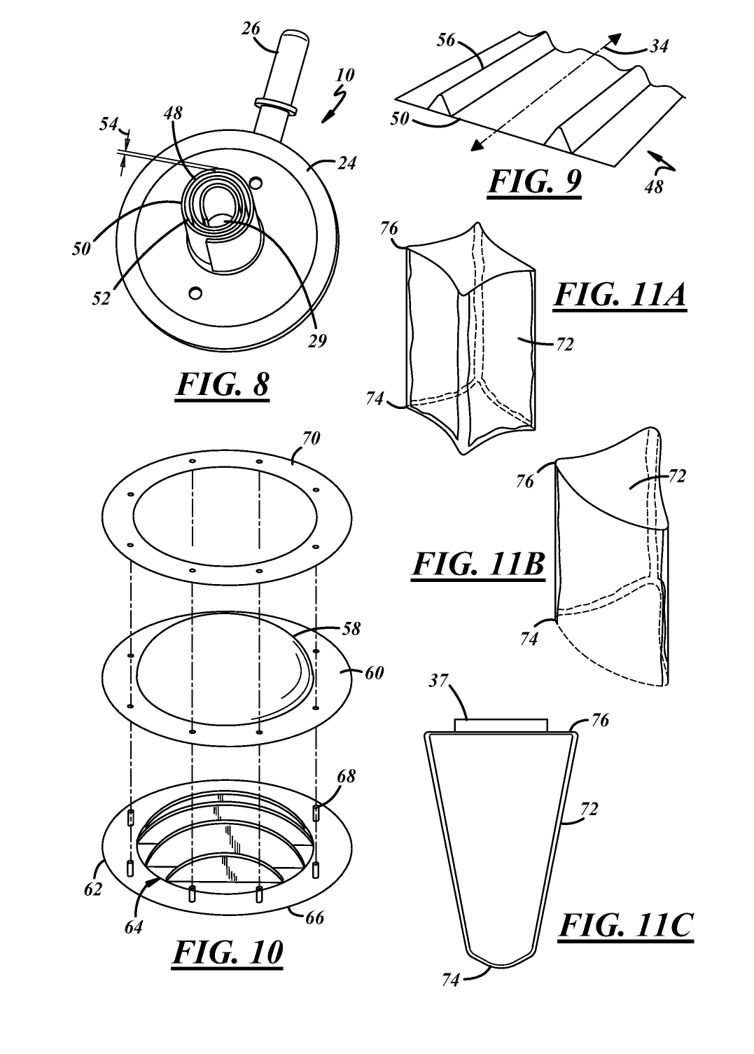

In accordance with another embodiment of the invention, the venting valve 10 may include a spiral-wound membrane package as generally illustrated in FIGS. 7-8. Elements of the venting valve 10 (including for example, but not limited to, cover 20, flange 24, flow path 26, means 28, housing 46) may be identical and/or substantially similar to the elements described in connection with other embodiments of the invention, except the membrane may comprise a spiral-wound membrane 48. Spiral-wound membrane 48 may be liquid discriminating and vapor permeable. Spiral-wound membrane 48 may be configured to allow for the passage of air and/or fuel vapor, while blocking the passage of liquid fuel. In accordance with an embodiment of the invention, the spiral-wound membrane 48 may be configured so that it does not change the hydrocarbon concentration of the air and/or fuel vapor that passes through the spiral-wound membrane 48. The spiral wound membrane 48 may be connected to venting valve 10 using means 28 described herein (e.g., post 29 and/or any known and/or conventional method and/or manner, including for example, an insert molding process, welding (e.g., ultrasonic welding), heat sealing, bonding (e.g., with adhesives), a combination thereof, or any number of other processes). In accordance with an embodiment of the invention, the means 28 may comprise a direct connection between membrane 22 and cover 20 in accordance with an embodiment of the invention such that no separate connecting element (such as projections or a post) is necessary.

The spiral-wound membrane 48 may comprise a substantially flat membrane that is first folded (e.g., folded in half) to make an envelope. The edges of the membrane 48 may be sealed in order to create a first vapor space inside the envelope and a second vapor space outside the envelope (e.g., the fuel tank vapor space). Accordingly, the membrane 48 may comprise a first and second layer 50, 52 (e.g., the first half of the substantially flat membrane is the first layer 50, and the second half of the substantially membrane is the second layer 52). The membrane 48 comprising the folded envelope may then be spirally wound (e.g., rolled up into a spiral-wound membrane 48).

The first and second layers 50, 52 of the membrane 48 may define a gap 54 therebetween. In one embodiment, the membrane 48 may be generally self-supporting to retain gap 54 between layers 50, 52. In other embodiments, the membrane 48 may use a device 56 that is configured to maintain the gap 54 between the first and second layer 50, 52 of the membrane 48. For example, the device 56 may comprise a runner.

Referring now to FIG. 9, device 56 is generally illustrated as a plurality of runners. The runners 56 may extend along the longitudinal axis 34 of the spiral-wound membrane 48 in an embodiment of the invention. In other embodiments, the runners 56 may extend perpendicularly to and/or at any other angle relative to the longitudinal axis 34 of the spiral-wound membrane 48. The runners 56 may extend the entire length of the first layer 50 and/or second layer 52 of the spiral-wound membrane 48 or may extend only along a portion of the first layer 50 and/or second layer 52 of the spiral-wound membrane 48. The runners 56 may generally comprise a flexible material and may comprise a plastic in an embodiment of the invention. The runners 56 may have a substantially triangular cross-section in an embodiment of the invention, although the runners may comprise any number of shapes in accordance with other embodiments of the invention. Each of the runners 56 may be attached to the membrane 48 through a process, such as insert molding, ultrasonic welding, etc. or be inserted as a separate piece between the layers 50, 52 of the membrane 48. The device 56 is not limited to runners as illustrated and may include any other device configured to create and/or maintain the gap 54 between the first and second layers 50, 52 of the spiral-wound membrane 48. For example and without limitation, in other embodiments, the device 56 may comprise a mesh, screen, net, braid, etc. The device 56 comprising a mesh, screen, net, braid, etc. may also comprise a flexible material and/or may also comprise plastic in accordance with embodiments of the invention.

The membrane 48 may also include a hole (not shown) for vapor flow. The hole may be in fluid communication with the flow path 26 of the cover 20. Vapor may flow from fuel tank 12, through layer 50 or layer 52 of membrane 48, through the gap 54 defined between layers 50 and 52 of membrane 48, through the hole of the membrane 48, through the flow path 26, and to the vapor recovery system 16. In this way, the membrane 48 provides two distinct vapor spaces (i.e., the first vapor space is inside the fuel tank 12, and the second vapor space is outside the fuel tank 12). The membrane envelope makes up part of the second vapor space outside the fuel tank 12.

In accordance with another embodiment of the invention, the venting valve 10 may include a dome membrane package as generally illustrated in FIG. 10. Elements of the venting valve 10 (including for example, but not limited to, cover 20, flange 24, flow path 26, post 28, housing 46) may be identical and/or substantially similar to the elements described in connection with other embodiments of the invention, except the membrane may comprise a dome membrane 58. Dome membrane 58 may also be liquid discriminating and vapor permeable. Dome membrane 58 may also be configured to allow for the passage of air and/or fuel vapor, while blocking the passage of liquid fuel. Membrane 58 may not generally be configured to filter the fuel vapor (i.e., substantially change (e.g., lower and/or increase) the hydrocarbon concentration of the fuel vapor) in an embodiment of the invention. At least a portion of dome membrane 58 may be generally curved and/or hemispherical in an embodiment of the invention. The dome membrane 58 may further include a circumferentially extending flange 60 that may be used to connect the dome membrane 58 to the venting valve 10.

In order to provide support and/or form the dome membrane 58 of the membrane package, a corresponding protrusion 62 may be provided. Protrusion 62 may comprise a rib member in accordance with an embodiment of the invention. For example and without limitation, protrusion 62 may comprise at least one curved rib 64 that is configured to support and/or shape the membrane 58. The dome membrane 58 may be configured to be provided and/or placed on the protrusion 62 (e.g., on a rib 64 of the protrusion 62 in an embodiment of the invention). Protrusion 62 may further comprise a circumferentially extending flange 66 in accordance with an embodiment of the invention. Flange 66 may include at least one lug and/or tooth 68. Lugs and/or teeth 68 may be used to hold the membrane 58 in place. In particular, lugs and/or teeth 68 may be used to hold flange 60 of membrane 58 in place against flange 66 of protrusion 62. A corresponding ring 70 that matches up with flanges 60 and 66 may also be used to retain membrane 58 in place. The dome membrane 58 may be connected to venting valve 10 so that the curved and/or hemispherical portion (i.e., the convex side) faces cover 20 of venting valve 10 in an embodiment. The dome membrane 58 may also be connected to venting valve 10 so that the curved and/or hemispherical portion (i.e., the convex side) faces away from cover 20 of venting valve 10 (i.e., toward fuel tank 12). The dome membrane 58 may be connected to venting valve 10 using post 28 described herein and/or any known and/or conventional method and/or manner, including for example, an insert molding process, welding (e.g., ultrasonic welding), heat sealing, bonding (e.g., with adhesives), a combination thereof, or any number of other processes. The dome membrane 58 may also be directly connected to cover 20 in accordance with an embodiment of the invention.

A first side of the dome membrane 58 (e.g., the convex side or concave side) may be in fluid communication with the vapor space inside the fuel tank 12. A second, opposing side of the dome membrane (e.g., the concave side or convex side, respectively) may be in fluid communication with the vapor space including flow path 26 of cover 20. Vapor may flow from fuel tank 12, through membrane 58, through the flow path 26, and to evaporative emissions system 16. In this way, the dome membrane 58 provides two distinct vapor spaces (i.e., the first vapor space is inside the fuel tank 12 and the second vapor space is outside the fuel tank 12).

Although these various embodiments have been described in detail, there may be numerous other variations for methods of packaging a membrane for use in a venting valve that may increase the surface area in order to improve the functionality of the membrane, while not requiring significant increases in physical space requirements for the venting valve. For example and without limitation, in other embodiments, the membrane may comprise a sock-type membrane package as generally illustrated in FIGS. 11A-11B. In the sock-type membrane package, the membrane 72 may comprise a hollow member formed by one or a plurality of panels. The membrane 72 may comprise four side panels as generally illustrated in FIG. 11A, and accordingly may comprise a rectangular shape. However, in other embodiments, the membrane 72 may comprise fewer or more panels (e.g., three side panels forming a triangular shape as generally illustrated in FIG. 11B). Although four side panels and three side panels are mentioned and generally illustrated, the membrane 72 may comprise any number and types of panels in various embodiments. For example, as generally illustrated in FIG. 11C, the membrane 72 may comprise a single panel formed into a V-shaped and/or wedge-shaped membrane package. A first end 76 of the membrane 72 may be wider than a second opposing end 74 of the membrane 72. One or more substantially triangular shaped pieces (not shown) may be used to seal the edges of the V-shaped and/or wedge shaped membrane package generally illustrated in FIG. 11C to maintain a closed inner vapor space separate from the fuel tank vapor space.

The membrane 72 may be sealed at a first end 74. As shown in FIGS. 11A-11B, a bottom panel may seal the multiple side panels of the hollow member through the use of seams.

As shown in FIG. 11C, the single panel of the V-shaped itself creates a sealed first end 74. The membrane 72 may include a plate 37 and/or an end cap (not shown) at a second end 76, the second end 76 opposing the first end 74. The end cap may be configured for retaining the shape of the hollow member in some embodiments of the invention. The end cap may be connected to the membrane 72 using any known and/or conventional method and/or manner in the art, including for example, adhesives. The end cap may include a hole for vapor flow. The hole in the end cap may be in fluid communication with the flow path 26 of cover 20. Vapor may thus flow from fuel tank 12, through membrane 72, through the hole of the end cap, through flow path 26, and to evaporative emissions system 26. In this way, the membrane 72 provides two distinct vapor spaces (i.e., the first vapor space is inside the fuel tank 12 and the second vapor space is outside the fuel tank 12). Although an end cap is described in detail, an end cap may not necessarily be used in connection with the embodiments of the invention. For example, the membrane 72 itself and/or plate 37 may include a hole for vapor flow, without the use of an end cap. The membrane 72 may be connected to venting valve 10 using means 28 described herein and/or any known and/or conventional method and/or manner, including for example, an insert molding process, welding (e.g., ultrasonic welding), heat sealing, bonding (e.g., with adhesives), a combination thereof, or any number of other processes.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. The invention has been described in great detail in the foregoing specification, and it is believed that various alterations and modifications of the invention will become apparent to those skilled in the art from a reading and understanding of the specification. It is intended that all such alterations and modifications are included in the invention, insofar as they come within the scope of the appended claims. It is intended that the scope of the invention be defined by the claims appended hereto and their equivalents.

What is claimed:

1. A venting valve, comprising:
a cover including a flow path in fluid communication with an evaporative emissions system; and
a liquid discriminating and vapor permeable membrane connected to the cover, wherein at least a portion of the outer surface of the membrane comprises a plurality of alternating curved crests and valleys.

2. The venting valve of claim 1, further comprising a means for connecting the membrane to the cover.

3. The venting valve of claim 2, wherein the means comprises insert molding, ultrasonic welding, heat sealing, adhesives, or a combination thereof.

4. The venting valve of claim 1, wherein the evaporative emissions system comprises a carbon canister.

5. The venting valve of claim 1, wherein the membrane is configured to prevent liquid from passing through the membrane.

6. The venting valve of claim 1, wherein the cover includes a flange configured to support the venting valve in a fuel tank of a vehicle fuel system.

7. The venting valve of claim 1, wherein the venting valve is configured for use between a vehicle fuel tank vent and the evaporative emissions system in a vehicle fuel tank containing liquid fuel.

8. The venting valve of claim 1, wherein the membrane extends perpendicularly from the cover.

9. The venting valve of claim 1, wherein the membrane is substantially columnar in shape.

10. The venting valve of claim 1, wherein the membrane forms a hollow member.

11. The venting valve of claim 10, further comprising a first end cap connected to a first end of the hollow member, the first end cap configured for sealing the first end of the hollow member and retaining the shape of the hollow member.

12. The venting valve of claim 11, further comprising a second end cap connected to a second end of the hollow member, wherein the second end cap includes a hole for vapor flow, wherein the hole is in fluid communication with the flow path of the cover.

13. The venting valve of claim 10, further comprising a structural support member extending through the hollow member.

14. The venting valve of claim 1, further comprising a housing that at least partially surrounds the membrane.

15. The venting valve of claim 1, wherein at least a portion of the outer surface of the membrane has a substantially sinusoidal profile.

16. The venting valve of claim 1, wherein at least a portion of the outer surface of the membrane has a substantially corrugated profile.

17. The venting valve of claim 1, wherein at least one of the plurality of curved crests or at least one of the plurality of curved valleys or a combination thereof has a profile that is at least substantially hemispherical.

18. The venting valve of claim 1, wherein at least one of the plurality of curved crests or at least one of the plurality of curved valleys or a combination thereof has a profile that extends greater than 180° of a circle.

19. The venting valve of claim 1, wherein at least one of the plurality of curved crests or at least one of the plurality of curved valleys or a combination thereof has a profile that extends at least 270° of a circle.

20. A venting valve, comprising:
a cover including a flow path in fluid communication with an evaporative emissions system; and
a liquid discriminating and vapor permeable membrane connected to the cover, wherein the membrane comprises a first and second layer defining a gap therebetween, and wherein at least a portion of the membrane is spirally wound.

21. The venting valve of claim 20, wherein the membrane includes a hole for vapor flow, wherein the hole is in fluid communication with the port of the cover.

22. The venting valve of claim 20, further comprising a device that is configured to maintain the gap between the first and second layer of the membrane.

23. A venting valve, comprising:
a cover including a flow path in fluid communication with an evaporative emissions system;
a liquid discriminating and vapor permeable membrane connected to the cover, wherein at least a portion of the membrane is curved; and
at least one protrusion configured to support and shape the membrane.
